(19) United States
(12) Patent Application Publication
(10) Pub. No.: US 2010/0007728 A1
(43) Pub. Date: Jan. 14, 2010

(54) System for Determining Objects

(75) Inventors: Matthias Strauss, Pfungstadt (DE); Jürgen Pfeiffer, Glashutten (DE); Adam Swoboda, Gross-Gerau (DE); Enrico Rück, Taucha (DE); Stefan Lüke, Olpe (DE); Stefan Heinrich, Achern (DE); Timo Seifert, Wangen (DE); Carsten Birke, Frankfurt am Main (DE); Robert Baier, Dieburg (DE)

Correspondence Address: RATNERPRESTIA, P.O. BOX 980, VALLEY FORGE, PA, 19482, US

(73) Assignee: Continental Teves AG & CO., oHG, Frankfurt (DE)

(21) Appl. No.: 12/444,879

(22) PCT Filed: Oct. 12, 2007
(86) PCT No.: PCT/EP2007/060917

§ 371 Date: Apr. 9, 2009

(30) Foreign Application Priority Data
Oct. 13, 2006 (DE) 10 2006 049 102.5

(51) Int. Cl. H04N 7/18

(52) U.S. Cl. 348/118; 348/E07.085

(57) ABSTRACT

A system for multimodal detection of objects in a field of vision located in front of or behind a vehicle, wherein a surroundings-sensing process is carried out by a radar sensor, the radar sensor output signal is fed to a radar signal analysis method, and a visual surroundings-sensing process is carried out by a video sensor, the video output signal being fed to a video analysis method. Object determination takes place such that objects detected by the radar signal analysis method are fed for verification to an object confirmation and situation analysis module by an object detected by the video analysis method.

### CROSS REFERENCE TO RELATED APPLICATIONS

This application is the U.S. national phase application of PCT International Application No. PCT/EP2007/060917 filed Oct. 12, 2007, which claims priority to German Patent Application No. DE 10 2006 049 102.5 filed Oct. 13, 2006, the contents of such applications being incorporated by reference herein.

### BACKGROUND OF THE INVENTION

1. Field of the Invention

The invention relates to the field of multimodal detection of objects on the basis of a surroundings model in road traffic.

2. Description of the Related Art

Systems for avoiding and reducing the severity of injuries due to accidents have hitherto essentially been developed separately and independently of the systems which serve to avoid accidents. The passive safety and the active safety of a vehicle have been considered independently of one another.

Nowadays, both the active safety and the passive safety rely on electronic systems such as the electronic stability programme (ESP), Adaptive Cruise Control (ACC), seat belt pretensioner and airbags. However, the potential of such systems cannot be used entirely unless all the subsystems have information about the driving state, the surroundings of the vehicle and the driver himself.

The effect of this interconnection is that a reduced stopping distance (RSD) is produced. In what is referred to a 30 metre car, the individual systems for active safety—tyres, chassis and brakes—are connected to form one optimized overall system. This overall system not only significantly reduces the braking distance to 30 metres but also the stopping distance—in addition with the reaction distance and threshold distance components.

Shortening the threshold distance which has been covered from the point of the first brake pedal contact to the point when the braking power is fully built up caused the electrohydraulic brake (EHB) to be combined with a braking assistant (BA). The EHB is defined by a particularly rapid buildup of pressure.

In order to shorten the reaction time, the vehicle is equipped, in a subsequent step, with a front-mounted radar which measures the distance and relative speed with respect to the vehicle travelling ahead. If said distance and speed indicate an emergency situation, the activated Adaptive Cruise Control (ACC) system initiates extraneous braking up to the legal limit of 0.2 to 0.3 g and requests the driver, by means of a signal, to take over control of the braking process if this extraneous braking is not sufficient. If the driver takes over control of the braking activities, he is supported by the extended braking assistant (BA+) which interconnects the information on the surroundings with the brake activation signal of the driver.

This interconnection of inter-vehicle distance information and braking information is also used when the ACC is switched off. This first step of interconnection already covers a large proportion of accidents in which the vehicle had previously been in a critical vehicle dynamic situation.

DE 199 28 915 A1 discloses a method with which the visibility range in the visibility range of a motor vehicle can be determined precisely so that the driver can be prompted to adopt an adapted driving style by means of the information on the visibility range. In this context, a monocular video sensor measures the contrast of an object which is sensed by a radar sensor or LIDAR sensor, and the visibility range is determined from the measured values which are supplied by the radar or LIDAR sensor and by the monocular video sensor. Alternatively, the distance between the at least one object and its contrast are measured by means of a binocular video sensor, and the visibility range is subsequently determined from the contrast measured values and the distance measured values. Apart from the measurement of contrast, no further evaluation of the image data recorded by the video sensor is carried out. Furthermore, it proves disadvantageous that the LIDAR sensors which are suitable for relatively large measuring ranges lose local resolution as the distance from an object increases, which has an adverse effect on the detection of objects.

DE 10305861 discloses a device of a motor vehicle for the spatial sensing of a scene inside and/or outside the motor vehicle with a LIDAR sensor which is coupled to an electronic detection device and an image sensor which is connected to an image processing device and has the purpose of recording and evaluating images of the scene, in which case the detection device and the image processing device are coupled to a computer for acquiring spatial data on the scene.

WO 03/006289 discloses a method for automatically triggering deceleration of a vehicle in order to prevent a collision with a further object, in which objects in the region of the course of the vehicle are detected as a function of radar signals or Lidar signals or video signals, and movement variables of the vehicle are acquired. A hazard potential is to be determined as a function of the detected object and the movement variables. In accordance with this hazard potential, the deceleration means are to be operated in at least three states. Furthermore, there is provision for the consequences of an imminent collision with a further object to be reduced by actuating passive or active restraint systems.

Methods and systems are known which are based on a beam sensor which assists the driver in initiating a braking process in a hazardous situation by prefilling the brake system when the accelerator pedal is released, will initiate a slight deceleration of up to 0.3 g (prebraking) during the time in which the driver does not touch any of the pedals, and the braking assistant engages earlier owing to relatively low threshold values when the brake is activated by the driver.

In spite of the very high efficiency of the systems, system-related, application-specific restrictions arise:

Stationary vehicles or objects are not detected by the beam sensors. As a result, classification is carried out with respect to the beam sensor properties of the object but not in respect of which object it actually is and whether it is in fact an object on the road, next to the road, below it or above it. This situation analysis cannot serve as a basis for initiating any strong autonomous braking processes, owing to the high level of uncertainty. Furthermore, the range of the sensor is always limited in the surroundings by vehicles or objects, and the coefficient of friction which is highly important for the engagement strategy and warning strategy is not known from the outset.

### SUMMARY OF THE INVENTION

The invention makes available a simple, robust system for differentiating objects in the surroundings of a vehicle in order to derive reliable braking strategies on this basis.

A system for multimodal detection of objects in a field of vision located in front of and/or behind a vehicle is disclosed herein, wherein a first surroundings-sensing process 30 is carried out by means of a first sensor 10, the sensor output signal is fed to a first sensor signal analysis method with an object-locating means 31, and a further surroundings-sensing process is carried out by means of a second sensor 20, the sensor output signal of the second sensor output signal 23 is fed to a second sensor signal analysis method with object-locating means 41, wherein objects which have been sensed by the sensors 10, 20 and detected and determined by the sensor signal analysis methods 31, 41 are fed for verification to an object confirmation and situation analysis module 42, wherein further vehicle information and the lane prediction (43) are taken into account in the verification, and objects (60) which are relevant for the object confirmation and situation analysis module (42) are determined, wherein measures for increasing the passive safety (120) are initiated by the relevant objects (60) and the driver information (80) when a hazardous situation is detected by the hazard computer (90).

In one advantageous refinement, a radar sensor is used as the first sensor 10, and a visual sensor 20 is used as the second sensor, wherein the sensors sense different ranges of the electromagnetic wave spectrum, and the system is integrated into a driver assistance system with a front sensor system.

One particularly advantageous refinement of the system is configured by virtue of the fact that the first sensor 10 is a radar sensor and the second sensor is a camera.

It is particularly advantageous that the system minimizes the data flow between the two sensors by preselecting relevant objects in the radar. The relatively small quantity of data to be evaluated considerably increases the computing speed for determining relevant objects.

In one particularly advantageous refinement of the invention, the sensing ranges of the video camera and radar are adapted, with the common sensing range which is determined, and is to be modelled and is of relevance, being monitored jointly by the sensors.

In a further refinement, a braking strategy is carried out with at least 0.3 g with an increase in deceleration just before the stationary state by means of the safety systems 120, as a result of which the sensation of emergency braking is generated.

This solution has the advantage that the invention involves target confirmation since the acquired data from the surroundings detection means are checked, verified and confirmed in order to permit the sensors to supplement one another, as result of which the transmission of data between the sensors can easily be implemented and it is not necessary to place any stringent technical requirements on the systems.

The invention involves target confirmation since the acquired data from the surroundings detection means are checked, verified and confirmed in order to permit the sensors to supplement one another, in which context the transmission or exchange of data between the sensors can easily be implemented and the systems do not have to meet any complex technical requirements.

In one advantageous refinement of the invention, the carriageway markings are used for improved situation analysis.

An exemplary embodiment of the invention is illustrated in the drawings and will be described in more detail below.

### BRIEF DESCRIPTION OF THE DRAWINGS

In said drawings:

FIG. 1 shows an overall view of the system according to aspects of the invention, and

FIG. 2 shows a graphic evaluation of the average probabilities of detection of a vehicle.

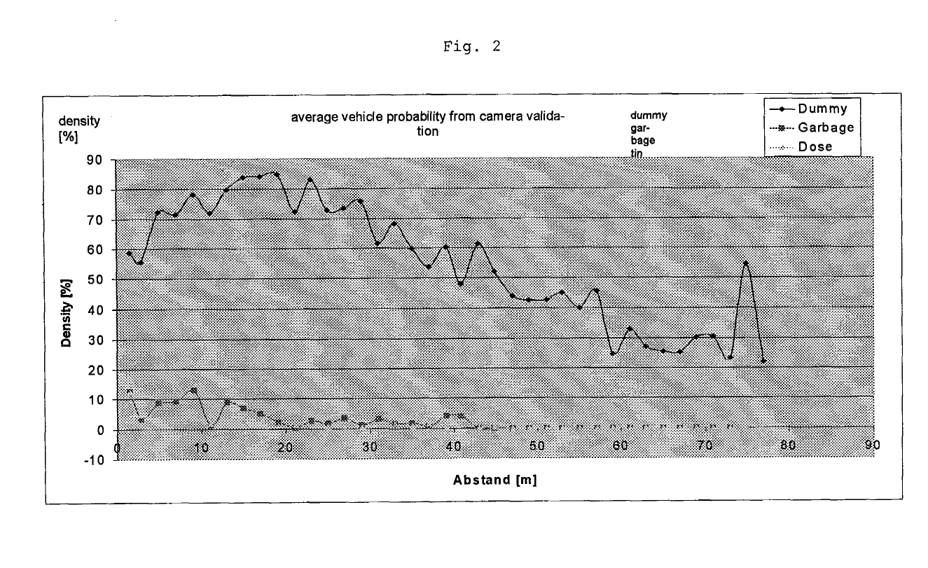

### DETAILED DESCRIPTION OF THE PREFERRED EMBODIMENTS

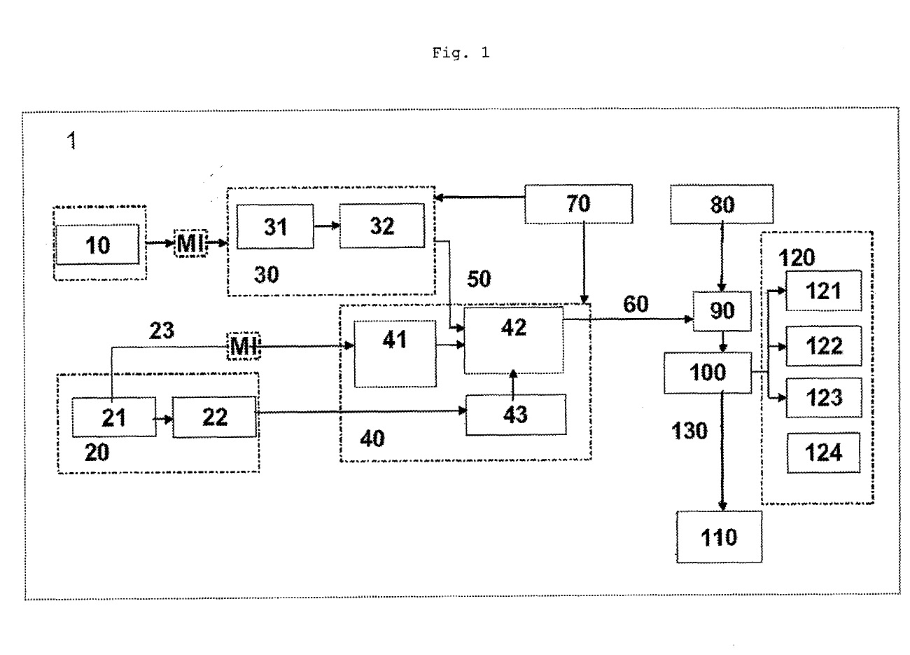

As is illustrated in FIG. 1, the radar sensor 10 initially carries out a preselection of relevant targets or objects 60. The position of these objects is signalled directly, or as is shown in FIG. 1, signalled indirectly to the camera via an object-determination means and a situation analysis means 42. If the camera can classify an object as relevant in a specific region, this is accepted as a relevant target or object. The principle during detection is to search for various optical characteristics of a vehicle at the position determined in the field of vision by the radar 10, at which position a target has been detected by the radar 10. Depending on whether a large number of characteristics or only a small number of characteristics have been detected, the detection rate increases, and therefore the probability increases that the detected object is, for example, a vehicle.

By using a radar close-range sensor system (24 GHz radar) 10, it is possible not only to implement comfort functions such as full speed range ACC or active parking aids with braking intervention and steering intervention but also improved safety functions. A further step in the direction of improved safety is the introduction of image-processing camera systems 20. They not only permit objects to be detected but also to be classified, which in turn results in improved activation of safety systems.

It is particularly advantageous for the system that the larger an object, the higher the probability that it will be detected as a vehicle. If the threshold value is set very low, the camera would confirm targets of the size of an average cardboard box. In addition, the probability of detection of the radar increases with the iron content of an object. That is to say, the larger an object and the more metal it contains, the higher the probability that an autonomous braking intervention will occur, which corresponds to the fact that the situation may also be a potentially dangerous one.

The system is completely installed in a vehicle 1. The radar sensor 10 has a very high longitudinal resolution. According to aspects of the invention, said radar sensor 10 is supplemented by a sensor 20 which has a very high lateral resolution, as already mentioned. A video sensor 20 is used for this. By means of the system, objects which are detected by the radar 10 are sensed by the object tracking means 31 and classified by the situation analysis means 32. The process of finding objects for sensor 132 contains three components. First, objects are detected and formed from the sensor data of the radar 10. Objects which have been found are assigned and tracked over time. In addition to the directly measurable object attributes such as size, distance and speed, metadata such as whether the object is a pedestrian, car or the meaning of a road sign are derived from the object features by classification. As a result, the object detection, object formation, object assignment, object tracking and object attribution as well as object classification sometimes take place in succession but frequently also in an alternating fashion and with feedback.

As a result of the object detection or object formation, specific objects are formed from the data of the sensor sensing process. In the case of the radar 10, for example reflection points which are located sufficiently close to one another and which have the same relative speed are combined to form one object. The same applies to the use of a Lidar system together with or separately from a radar 10. Here, for example scanning points which are at the same distance and are adjacent are combined in the first step to form an object hypothesis. In 2-D images of the camera sensor 20, various detection methods are used on the basis of the object positions, detected by the radar and/or the Lidar, for object formation, and the features such as shape, colour, edges, histograms from the image analysis or else the optical flow in the object tracking means for the visual sensor 41 are used. The computational work can be minimized overall in particular by the restriction of the visual object detection to the regions in which objects have already been detected by the radar and/or Lidar.

The object assignment process relates both to the identification of the same object in different sensor data and to the object tracking means 31, 41 over time. For this purpose, sufficiently precise location calibration and time calibration of the sensors 10 and 20 takes place.

According to aspects of the invention, a differentiation is made as to with which weighting, whether and how the different sensor data are processed by the radar 10 and the camera image 23. For example, it is contemplated that the sensor data to be included in the image, as it were with equal priority or with a master sensor in the configuration as a camera of the necessary and useful additional information in the form of vehicle information 70 from other sensors for verification by the preselection according to aspects of the invention of regions of interest by radar 10. In this context, attention is paid to the fact that a minimum data flow to be configured or a minimum data volume is generated. The object tracking means 31 and 41 takes into account as a result the time sequence of the sensor data and comprises the prediction of the movement behaviour of objects.

The situation analysis process 32 and 42 defines and describes the relationships between the objects which are found, such as for example vehicles cutting into a lane or travelling in an alley an inter-vehicle distance display, inter-vehicle distance warning system, adaptive cruise controller, traffic jam assistant, emergency braking system etc., different abstraction steps in the system analysis 32 and 42 such as distance from the vehicle travelling ahead, taking into account the driver's own speed, situation of vehicles cutting into a lane, possible avoidance manoeuvres. In addition to the data from the surroundings sensor system, the invention contemplates using prior knowledge, for example from digital maps and communication with other vehicles and/or the infrastructure.

All of the information available about the current situation is stored in an object confirmation and situation analysis system 42 and is available to all the passive and active safety systems 120 to be addressed, via the hazard computer 90 and the arbitration system 100. This is because the consideration of the current traffic situation which is to be considered with the driver's own action planning system permits risks to be assessed and therefore corresponding handling to be derived.

This redundance and complementary aspect contributes to decisively to the robustness and reliability of the multi-sensor surroundings sensor system since two modules are used for object detection, object tracking and for situation analysis 32, 43 in the system. The object confirmation and situation analysis system 42 serves to provide the attributed objects with metainformation. The determination of whether a detected object is an important object or not is carried out with statistical classifiers which, depending on the sensor system 10, 20 used, take into account a plurality of features in the decision.

Depending on the classification of the object, the safety system 120 is activated in the form of a control unit 110 the brake request to the electronic brakes from the radar-based situation analysis since static or dynamic objects 50 have been detected.

In parallel, as already mentioned, objects which cannot be measured with a radar sensor 10 are additionally detected. For example lanes which are used to improve the prediction about the probable behaviour of a detected object such as a vehicle or else that of the driver's own vehicle. The lane finding means 22 performs an active role in the detection process and is implemented, for example, by means of Kalman filters. A significantly more differentiated intervention decision is possible through knowledge of the profile of the lane markings and the higher lateral measuring precision of the detected objects.

On the basis of the more reliable situation analysis and its result it is possible to intervene to a significantly greater degree than previously in the driving behaviour of the vehicle. The previously implemented braking intervention was limited voluntarily to 0.3 g owing to the inadequate surroundings model. This limitation can be eliminated or can be at least raised. Firstly, braking with 0.6 g appears advantageous and appropriate since the range above 0.4 g is perceived as dangerous by the driver. In addition, the system is then functionally capable even when the carriageway is wet with rain (mu=0.7).

When higher decelerations occur, the driver could then depress the accelerator pedal again, thereby aborting the intervention.

Furthermore, the hazard computer 90 can be used to generate actuation variables for closing vehicle openings 122 in order to improve further the passive safety as a function of the hazard potential which is determined. The windows and the sunroof 122 are preferably closed when an accident is imminent. If the hazard potential rises further and a crash is directly imminent, the vehicle occupants are protected and positioned by means of an electromotive, reversible seat belt pretensioner 121, and the risk of the vehicle occupants being injured is reduced.

Optical and/or haptic warning messages and/or steering messages or behaviour instructions for warning 123 and/or directing the driver to a driver reaction which is appropriate for the current vehicle situation are advantageously provided the warning messages are preferably issued by means of a vibrating pedal 124 and/or a vibrating seat and/or an acoustic indicator and/or a visual display.

The steering messages are transmitted by means of a changed operating force to at least one pedal and/or the steering wheel so that the driver is made to steer the vehicle in a way which is appropriate for the situation by means of the increasing or decreasing operating force.

The functions of the hazard computer 90 comprise essentially calculating vehicle dynamics characteristic data, calculating hazard potentials and calculating the actuation signals.

The hazard computer 90 assesses the situation in a suitable way and determines the hazard potentials.

The hazard potential is defined as a dimensionless variable in the range between 0 and 100. The hazard potential is dependent on the acceleration which is necessary during the driving manoeuvre that has to be carried out in order to prevent the accident. The greater the necessary acceleration, the more dangerous the situation and the more dangerous the driving manoeuvre is perceived as being by the vehicle occupants. The conversion of the necessary acceleration into a hazard potential differs for the lateral acceleration and the longitudinal acceleration. A lower necessary lateral acceleration generates a relatively high comparable hazard potential.

The passive and active safety systems are actuated only on the basis of threshold value interrogations of the hazard potentials. In this context, a plurality of hazard potentials can be combined in order to activate a passive and active safety system. This means that the state of evaluation initially does not include the selection or the activation metering of the passive and active safety systems. In this context, a certain situation is assessed by means of a plurality of hazard potentials. This permits more extensive assessment of the situation. There are hazard potentials which assess the situation independently of the passive and active safety systems. Therefore, there may be, for example, a hazard potential which assesses the longitudinal dynamic driving state. Correspondingly, there is a generally valid hazard potential which describes the lateral dynamic driving state. In contrast to these generally valid hazard potentials, there are specific hazard potentials which are tailored to certain passive and active safety systems. These hazard potentials allow for the fact that different passive and active safety systems also have different activation times. This means that the same situation is comparatively more critical for a passive and active safety system with a long activation than for one with a short activation time than for one with a short activation time. There are therefore generally valid hazard potentials which are tailored specifically to passive and active safety systems.

The arbitration unit 110 which is provided in the electronic control system preferably has an automatic state system which arbitrates, in correlation with actuation variables which are dependent on the hazard potential, on the basis of variables which represent the accelerator pedal travel, the accelerator pedal speed and the changeover time between the accelerator pedal and brake pedal and/or the state (on/off) of the brake light and/or measured and/or calculated brake pressures of the brake system and/or the vehicle acceleration and/or their derivations, and enables prespecified braking pressure values of the hazard computer as a function of the result. Depending on the development of the hazard potential (value and/or gradient), the activating intervention, such as the brake intervention, can also take place autonomously, i.e. counter to the driver's wish. The autonomous activation intervention, such as braking intervention, is limited here with respect to the value of the actuation variable, such as the brake pressure.

Actuating interventions for the deceleration devices of the active and passive safety systems of the vehicle are then made available as a function of the state of the arbitration unit 100, said actuating interventions including various brake pressure requests which extend from prefilling of the brake system to reduction of the response time and as far as the maximum application of brake pressure.

For this purpose, the automatic state system evaluates the behaviour of the driver and enables prespecified brake pressure values of the hazard computer as a function thereof. Essentially the foot movement of the driver is evaluated. This permits conclusions to be drawn as to how dangerous the driver estimates the same situation as being or whether he has at all detected a critical situation. Brake pressure is built up independently of the driver only if the driver confirms this critical situation.

To conclude, it should be noted once more that the invention involves a target confirmation since the data are checked, verified and confirmed in order to permit the sensors to complement one another, as a result of which the transmission of data between the sensors can easily be implemented and stringent technical demands are not made of the system.

While preferred embodiments of the invention have been described herein, it will be understood that such embodiments are provided by way of example only. Numerous variations, changes and substitutions will occur to those skilled in the art without departing from the spirit of the invention. It is intended that the appended claims cover all such variations as fall within the spirit and scope of the invention.

1.-6. (canceled)

7. A system for multimodal detection of objects in a field of vision located in front of and/or behind a vehicle,
wherein a first surroundings-sensing process is carried out by a first sensor, a sensor output signal of the first sensor being fed to a first sensor signal analysis method with an object-locating means, and a further surroundings-sensing process is carried out by a second sensor, a sensor output signal of the second sensor is fed to a second sensor signal analysis method with object-locating means,
wherein objects which have been sensed by the sensors and detected and determined by the sensor signal analysis methods are fed for verification to an object confirmation and situation analysis module, wherein further vehicle information and a lane prediction are taken into account in the verification, and objects which are relevant for the object confirmation and situation analysis module are determined, wherein measures for increasing passive safety are initiated by the relevant objects and driver information when a hazardous situation is detected by a hazard computer.

8. The system according to claim 7,
wherein the first sensor is a radar sensor and the second sensor is a visual sensor, wherein the sensors sense different ranges of an electromagnetic wave spectrum, and the system is integrated into a driver assistance system with a front sensor system.

9. The system as claimed in claim 7,
wherein the first sensor is a radar sensor and the second sensor is a camera.

10. The system according to claim 9,
wherein data flow between the sensors is minimized by preselecting relevant objects in the radar.

11. The system according to claim 9,
wherein the camera is a video camera, and
wherein sensing ranges of the video camera and radar are adapted and the range sensed by the radar is evaluated by the video camera.

12. The system according to claim 7,
wherein a braking strategy with at least 0.3 g with an increase in deceleration just before a stationary state is carried out by safety systems of the vehicle, as a result of which a sensation of emergency braking is generated for a driver of the vehicle.

13. A system for multimodal detection of objects in a field of vision located in front of and/or behind a vehicle, said system comprising:
a first sensor that is configured to carry out a first surroundings-sensing process by generating a sensor output signal,
a second sensor that is configured to carry out a further surroundings-sensing process by generating a sensor output signal, and
a computer that is configured to: (i) receive the sensor output signals, (ii) analyze objects which have been sensed by the sensors, (iii) determine which objects are relevant, and (iv) initiate measures for increasing passive safety when a hazardous situation is detected.
